(19) United States
(12) Patent Application Publication
(10) Pub. No.: US 2023/0289815 A1
(43) Pub. Date: Sep. 14, 2023

(54) MEASURE ASSISTANCE DEVICE, MEASURE ASSISTANCE METHOD, AND RECORDING MEDIUM

(71) Applicant: NEC Corporation, Minato-ku, Tokyo (JP)

(72) Inventors: Satoshi Sakakibara, Tokyo (JP); Yusuke Iwasaki, Tokyo (JP); Akio Kawachi, Tokyo (JP); Yuya Hanzawa, Tokyo (JP); Xiaoyu Song, Tokyo (JP)

(73) Assignee: NEC Corporation, Minato-ku, Tokyo (JP)

(21) Appl. No.: 18/021,464

(22) PCT Filed: Sep. 28, 2020
(86) PCT No.: PCT/JP2020/036631

§ 371 Date: Feb. 15, 2023

(51) Int. Cl. G06Q 30/015; G06Q 30/0203

(52) U.S. Cl. CPC G06Q 30/015; G06Q 30/0203

(57) ABSTRACT

This measure assistance device comprises: a measure plan identification unit that identifies a measure plan relevant to a factor that has caused a customer in hierarchical segments to move to a higher-level segment; a measure selection unit that selects a measure from among a plurality of the measure plans on the basis of the number of use intentions acquired on the assumption that the measure plan is executed; and a measure inspection unit that inspects the measure on the basis of a change in customer distribution of the hierarchical segments through execution of the measure.

### TECHNICAL FIELD

The present disclosure relates to a measure assistance device and the like.

### BACKGROUND ART

Various measures for sales promotion are implemented for new and existing customers. For effective marketing activities, it is important to appropriately approach customers according to the customer segment. The customer segment is, for example, a group of customers divided by age, gender, area in which they live, trend of behavior, and the like. PTL 1 discloses a tool capable of easily measuring an approach for sales promotion according to a customer segment and performing segment analysis necessary for the measure.

### CITATION LIST

### Patent Literature

[PTL 1] JP 6656546 A

### SUMMARY OF INVENTION

### Technical Problem

In the hierarchized customer segment as described in PTL 1, sales of good customers belonging to the upper segment may account for 80% of the total sales. On the other hand, customers do not always belong to the same segment, but move dynamically in the long term. The customers of the highest-level segment leave the segment at a certain ratio. For this reason, measures for developing new customers included in the lower segment and making existing customers good customers as many as possible are required.

As a result of implementing measures for customers, if an appropriate measure for making a customer of a segment a customer of a higher-level segment, for example, an approach for sales promotion cannot be selected, the measure is useless and the implementation cost increases. On the other hand, when it is not possible to objectively evaluate the measures as to how effective the measures will be, the measure cannot be reflected in the next measures.

An object of the present disclosure is to provide a measure assistance device or the like capable of assisting in creating a measure effective for moving the segment of a customer.

### Solution to Problem

A measure assistance device as a first aspect of the present disclosure includes a measure plan identification unit that identifies a measure plan relevant to a factor by which a customer in a hierarchical segment has moved to a higher-level segment, a measure selection unit that selects, based on the number of use intentions if the measure plan were implemented, a measure from a plurality of the measure plans, and a measure verification unit that verifies the selected measure based on a change in customer distribution of the hierarchical segment before and after implementation of the selected measure.

A measure assistance method as a second aspect of the present disclosure includes identifying a measure plan relevant to a factor by which a customer in a hierarchical segment has moved to a higher-level segment, selecting, based on the number of use intentions if the measure plan were implemented, a measure from a plurality of the measure plans, and verifying the selected measure based on a change in customer distribution of the hierarchical segment before and after implementation of the selected measure.

A measure assistance program as a third aspect of the present disclosure causes a computer to execute identifying a measure plan relevant to a factor by which a customer in a hierarchical segment has moved to a higher-level segment, selecting, based on the number of use intentions if the measure plan were implemented, a measure from a plurality of the measure plans, and verifying the selected measure based on a change in customer distribution of the hierarchical segment before and after implementation of the selected measure.

The program may be stored in a non-transitory computer-readable/writable recording medium.

### Advantageous Effects of Invention

According to the measure assistance device or the like of the present disclosure, it is possible to assist in creating a measure effective for moving the segment of a customer.

### BRIEF DESCRIPTION OF DRAWINGS

FIG. 1 is a block diagram illustrating a configuration example of a measure assistance system according to the first example embodiment.

FIG. 2 is a block diagram illustrating a configuration example of a database according to the first example embodiment.

FIG. 3 is a block diagram illustrating a configuration example of a measure assistance device of the first example embodiment.

FIG. 4 is a diagram illustrating an example of a hierarchical segment.

FIG. 5 is a diagram illustrating another example of a hierarchical segment.

FIG. 6 is a diagram illustrating an image of a face-to-face survey on a customer allocated to a higher-level segment.

FIG. 7 is a diagram illustrating an example of face-to-face survey data.

FIG. 8 is data illustrating an example of a measure plan identified by a measure plan identification unit.

FIG. 9 is a diagram illustrating an example of a result of a market survey for a measure plan.

FIG. 10 is a diagram illustrating an example of a change in customer distribution before and after implementation of a measure.

FIG. 11 is a diagram illustrating an example of a change in another customer distribution before and after implementation of a measure.

FIG. 12 is a flowchart illustrating an operation example of the measure assistance device of the first example embodiment.

FIG. 13 is a block diagram illustrating a configuration example of a measure assistance device according to the second example embodiment.

FIG. 14 is a flowchart illustrating an operation example of the measure assistance device of the second example embodiment.

FIG. 15 is a block diagram illustrating a hardware configuration example of a computer.

### EXAMPLE EMBODIMENT

### First Example Embodiment

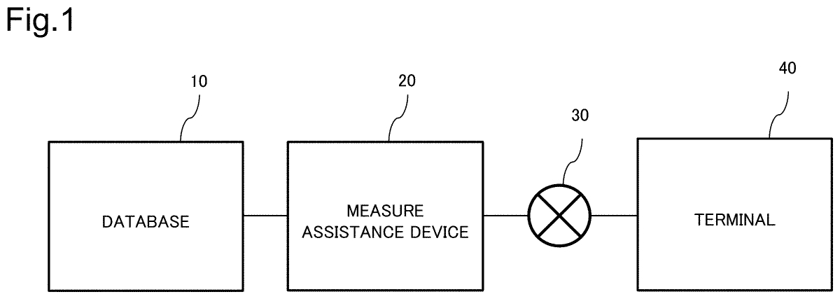

A measure assistance system according to the first example embodiment will be described with reference to the drawings. FIG. 1 is a block diagram illustrating a configuration example of the measure assistance system according to the first example embodiment. The measure assistance system illustrated in FIG. 1 includes a database 10, a measure assistance device 20, and a terminal 40. The measure assistance device 20 and the terminal 40 are communicably connected via a network 30. The measure assistance device 20 and the database 10 may be communicably connected via the network 30. An example of a hardware configuration of the database 10 includes a memory, a storage, or a network storage. The measure assistance device 20 and the terminal 40 are configured by, for example, a computer.

(Database)

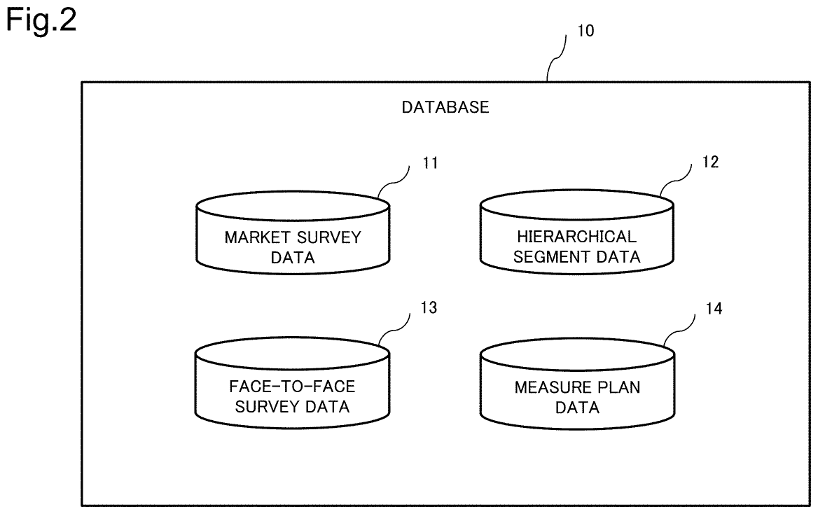

Data stored in the database 10 will be described. FIG. 2 is a block diagram illustrating a configuration example of a database according to the first example embodiment. The database 10 stores market survey data 11, hierarchical segment data 12, face-to-face survey data 13, and measure plan data 14.

The market survey data 11 includes questionnaire data. The questionnaire data includes, for example, a question, an answer to the question, and attribute information (for example, area, age, and the like) of a respondent who has answered the question. The market survey data is collected and accumulated at predetermined monthly intervals (for example, one month, six months, one year, and the like). The questions are, for example, about brand recognition, a purchase experience, and a purchase amount or a purchase frequency. The brand is a sign that is generally identified by a customer by a product or service. The brand herein may be a product or a service, or may be a provider that provides a product or a service.

The hierarchical segment data 12 stores data related to the hierarchical segment. For example, it stores data of the hierarchical segment before and after implementation of a certain measure. The hierarchical segment data 12 may be data of the hierarchical segment to which the customer allocation unit 21 of the measure assistance device 20 has allocated a customer based on the questionnaire data. The data of the hierarchical segment includes the number of customers in each segment or the ratio of the number of customers in each segment to all segments or all customers. The data of the hierarchical segment may be, for example, the number of customers in each segment in 10,000 people or the ratio of the number of customers in each segment in all segments. The hierarchical segment is, for example, a customer pyramid. The hierarchical segment may be a 6 segment map and a 11 segment map.

The face-to-face survey data 13 is data of an interview with each customer allocated to the higher-level segment among the customers allocated to the hierarchical segments, compared with a segment allocated based on the past market survey data. In the interview, for example, a trigger for purchasing a brand product or service, a reason for purchasing, a feeling of satisfaction after purchasing, and the like are questioned. The face-to-face survey data 13 may include attribute information (area, age, etc.) of the customer who answered in addition to the answer to the question.

The measure plan data 14 includes data of a measure plan that has been implemented or data of an unimplemented measure plan.

Alternatively, the measure plan data 14 may include a measure plan created based on the face-to-face survey data 13. A measure plan identified in the past by the measure plan identification unit 22 of the measure assistance device 20 may be included in the measure plan data 14.

(Measure Assistance Device)

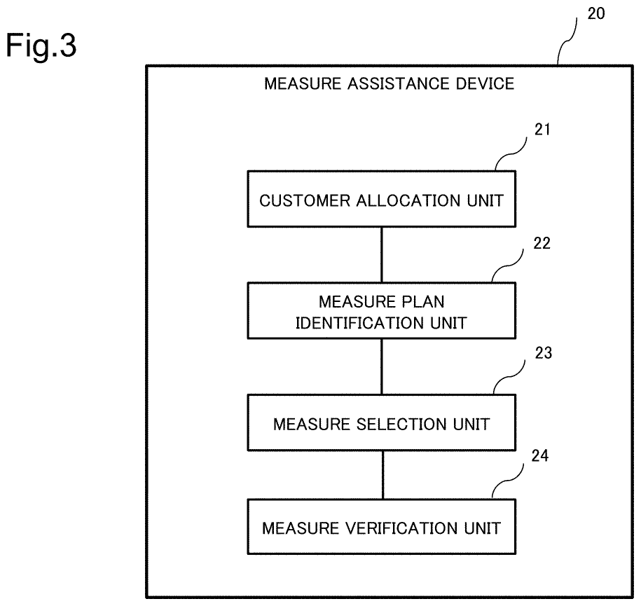

The measure assistance device 20 according to the first example embodiment will be described with reference to the drawings. FIG. 3 is a block diagram illustrating a configuration example of the measure assistance device of the first example embodiment. The measure assistance device 20 illustrated in FIG. 3 includes a customer allocation unit 21, a measure plan identification unit 22, a measure selection unit 23, and a measure verification unit 24.

The customer allocation unit 21 allocates a customer to the hierarchical segment based on the brand recognition, the purchase experience, and the purchase amount or the purchase frequency with respect to the customer. Specifically, the customer allocation unit 21 acquires questionnaire data for the brand included in the market survey data 11 from the database 10. The customer allocation unit 21 allocates a customer to the hierarchical segment based on the brand recognition included in the questionnaire data, the purchase experience, and the purchase amount or the purchase frequency.

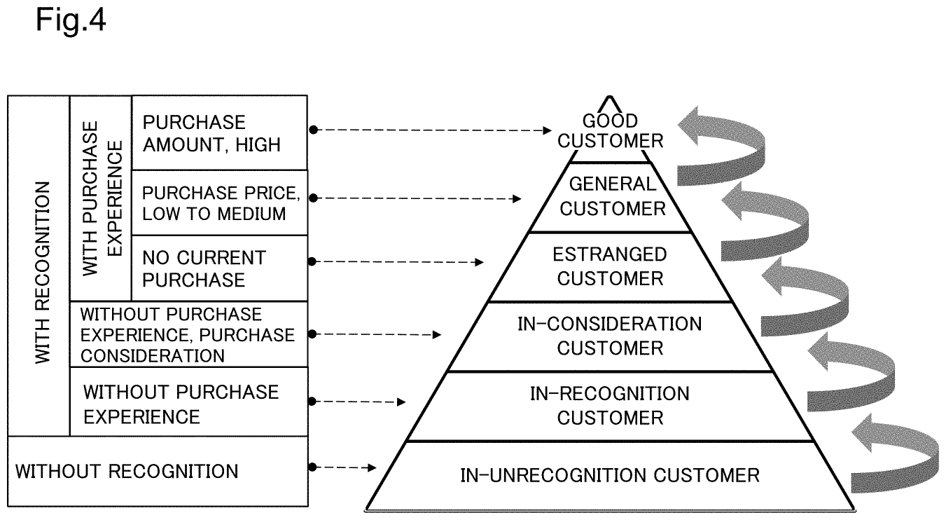

FIG. 4 is a diagram illustrating an example of the hierarchical segment. The hierarchical segment illustrated in FIG. 4 is an example of a six-segment map. The six segment map is a map that divides customers into six segments of the good customer, the general customer, the estranged customer, the in-consideration customer, the in-recognition customer, and the in-unrecognition customer. The six segment map is determined based on questionnaire data regarding presence or absence of the brand recognition, presence or absence of the purchase experience (including purchase consideration), the purchase amount, and the like. The item of the purchase amount may be a purchase frequency.

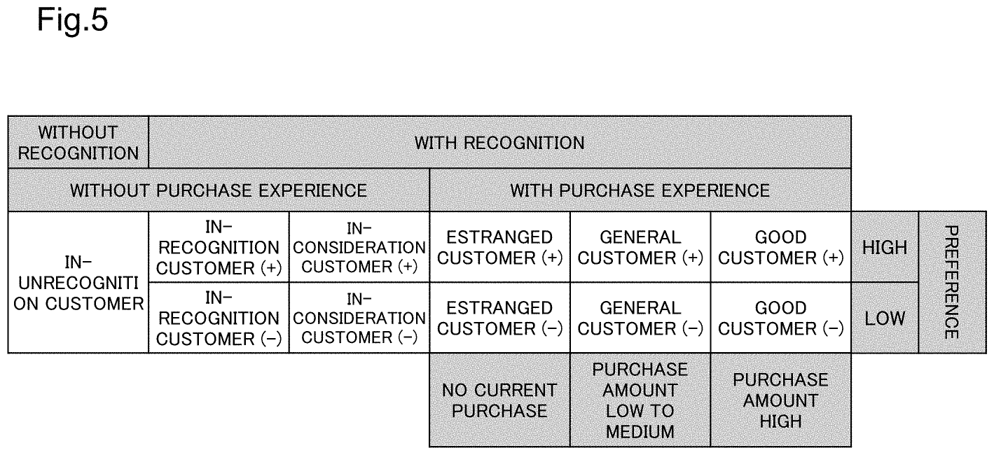

FIG. 5 is a diagram illustrating another example of the hierarchical segment. The hierarchical segment illustrated in FIG. 5 is an example of a 11 segment map. The 11 segment map includes 11 segments including segments obtained by dividing each of the top 5 segments among the 6 segments illustrated in FIG. 4 into two according to the preference of the brand and the segment of the in-unrecognition customer. Specifically, as illustrated in FIG. 5, each of the good customer, the general customer, the estranged customer, the in-consideration customer, and the in-recognition customer excluding the in-unrecognition customer are divided into (+) indicating affirmative and (−) indicating passive, with “high” and “low” of the preference as an axis.

In the preference, it is determined whether to be positive or negative with respect to the brand by the affirmative or passive answer to the question to the customer. The question of the preference to the customer is, for example, whether the customer likes or dislikes the target product, whether the customer has an intention of repurchasing the target product, or whether the customer recommends the target product to others. The percentage of preference can determine whether the branding is successful in each segment.

In a case where the 11 segment map is used as the hierarchical segment, the customer allocation unit 21 allocates a customer to the hierarchical segment based on the brand recognition, the purchase experience, the purchase amount or the purchase frequency, and preference indicating a next purchase intention.

The customer allocation unit 21 generates the number of customers or the ratio of the number of customers of each segment as data of the hierarchical segment. The data of the hierarchical segment may be, for example, the number of customers in each segment in 10,000 people or the ratio of the number of customers in each segment in all segments.

In the above description, the 6 segment map and the 11 segment map have been used as an example of the hierarchical segment in which the customers are allocated, but the present invention is not limited thereto, and other segment maps can be applied.

In the description of the first example embodiment, the customer allocation unit 21 classifies the customers into the plurality of ranked segments based on the questionnaire data, but the present invention is not limited thereto. For example, as long as the change in the customer distribution can be visible for each segment, the data of the hierarchical segment in which the customers are allocated may be used without using the customer allocation unit 21.

The measure plan identification unit 22 identifies a measure plan relevant to a factor by which the customer of the hierarchical segment has moved to a higher-level segment. Specifically, the measure plan identification unit 22 identifies a measure plan based on data of a face-to-face survey on a customer who has moved to the higher-level segment.

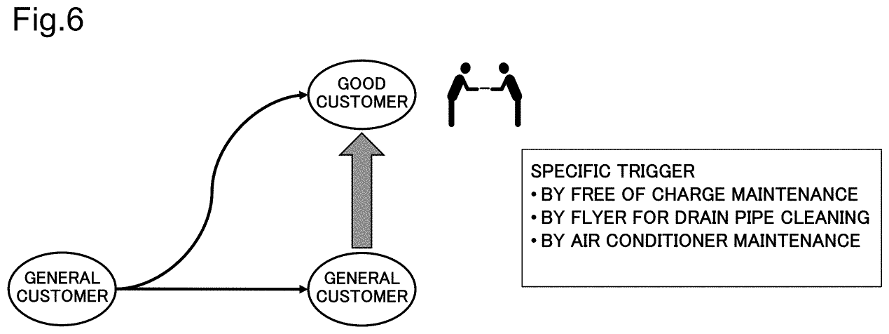

FIG. 6 is a diagram illustrating an image of a face-to-face survey on a customer allocated to a higher-level segment. FIG. 6 illustrates a face-to-face survey on a customer who has moved from a segment of a general customer to a segment of a good customer. Here, the movement to the higher-level segment means the movement to a higher-level segment by at least one level. For example, a customer who has moved from a segment of an estranged customer to a segment of a good customer may be subjected to face-to-face survey.

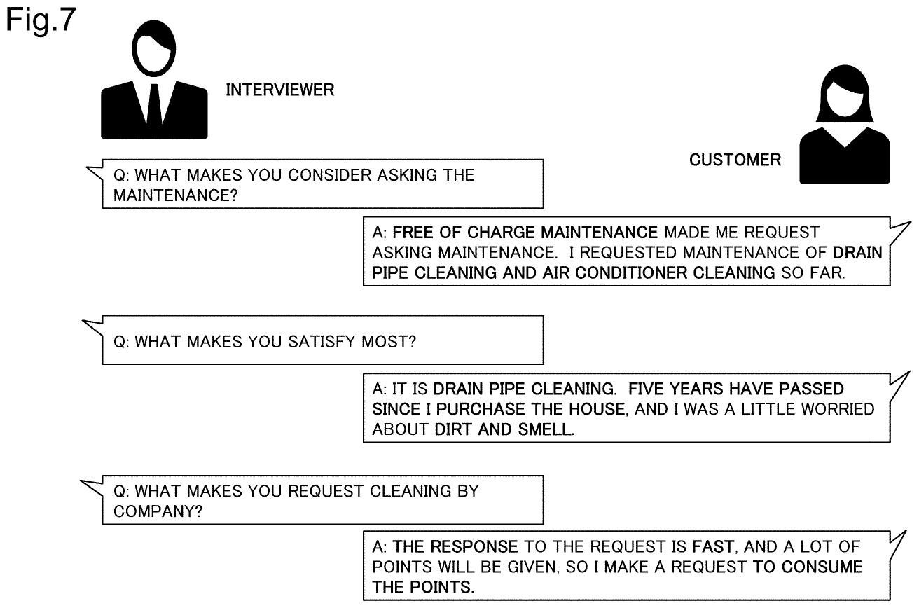

FIG. 7 is a diagram illustrating an example of face-to-face survey data. The face-to-face survey data illustrated in FIG. 7 is a question from the interviewer and an answer to the question from a customer who has moved to a higher-level segment. In the interview, a question about a trigger for purchasing a brand product, a reason for the purchase, a feeling of satisfaction after the purchase, and the like is asked, and the question is answered with a specific content.

For example, the measure plan identification unit 22 searches the measure plan data 14 of the database 10 for a measure plan relevant to an answer using a product or a service included in an answer by a customer who has moved to the higher-level segment as a keyword. Based on the search result, the measure plan identification unit 22 identifies a measure plan relevant to a factor by which the customer has moved to the higher-level segment. The identification of the measure plan by the measure plan identification unit 22 is not limited to the search using the product or the service as the keyword. For example, a similar measure plan may be identified based on attribute for each measure plan. Specifically, variables such as “discount basis/contact opportunity basis”, “direct face-to-face basis/mass media basis”, and “period continuation basis/single basis” may be given for each measure, and measure plans that largely match attributes included in the answers of the customers who have moved to the higher-level segment may be identified as a measure plan.

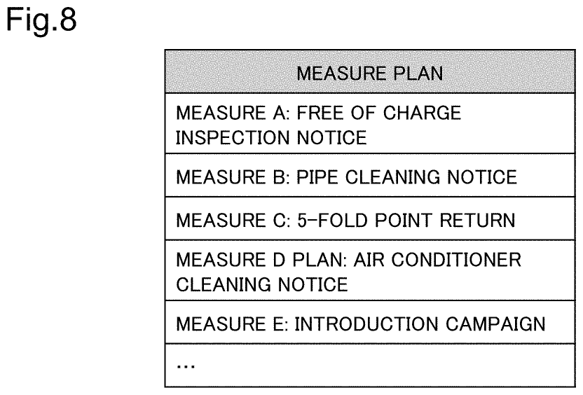

FIG. 8 is data illustrating an example of a measure plan identified by the measure plan identification unit. Data of the measure plans illustrated in FIG. 8 represents the “measure A: free of charge inspection notice”, the “measure B: pipe cleaning notice”, the “measure C: 5-fold point return”, the “measure D plan: air conditioner cleaning notice”, the “measure E: introduction campaign”, and the like.

The measure plan identification unit 22 sends the identified measure plan to the measure selection unit 23. The measure plan identification unit 22 may temporarily store the identified measure plan in the measure plan data 14 of the database 10.

The measure plan identification unit 22 can grasp the factor of the customer who has moved to the higher-level segment, and extracts a measure plan relevant to the factor. The possibility that another customer who purchases a product or a service moves to the higher-level segment increases by implementing the identified measure plan.

The measure selection unit 23 selects a measure from among a plurality of measure plans based on the number of use intentions if the measure plan were implemented. Specifically, the measure selection unit 23 selects a measure from the measure plans based on the market survey data 11 for the measure plans.

The market survey for the measure plan is a survey on whether the measure plan is used if the measure plan were implemented. The number of use intentions means the number of respondents who answered “use” if the measure plan is implemented in market survey. The number of respondents who have indicated intention to use the measure plan can be estimated as the number of users of the measure plan.

The measure selection unit 23 acquires data of the market survey for the measure plan identified from the market survey data 11 of the database 10. The measure selection unit 23 calculates the number of use intentions if the measure plan were implemented based on the acquired data of the market survey. The measure selection unit 23 selects a measure from a plurality of measure plans based on the number of use intentions. The measure selection unit 23 may calculate the number of use intentions for attribute of each respondent who has expressed the use intention. The measure selection unit 23 selects a measure from the measure plans based on the number of use intentions for each measure plan.

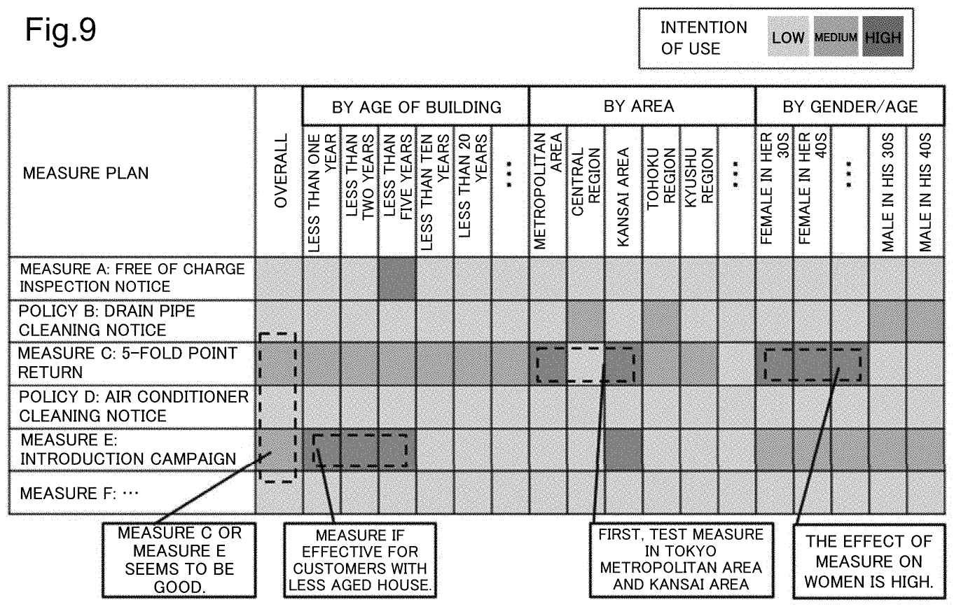

FIG. 9 is a diagram of data illustrating an example of a result of market survey for a measure plan. The result of the market survey illustrated in FIG. 9 indicates a distribution of the number of respondents who indicate intention to “use” for each measure plan, that is, a distribution of the number of use intentions. The use intention “small”, “medium”, and “large” illustrated in FIG. 9 are obtained by adding the number of respondents who indicate the use intention for each measure plan and classifying the added number of respondents into three levels by a predetermined threshold value.

The results of the market survey in FIG. 9 include a cell indicating the overall result (not depending on the attribute of the respondent) and a cell indicating the attribute of the respondent (by age of building, by area, by gender/age). In the cell showing the overall result, the measure C: 5-fold point return campaign or the measure E: introduction campaign has a larger distribution of intention to use than other measures.

The measure selection unit 23 selects a measure from a plurality of measure plans based on the number of use intentions if a measure plan were implemented, thereby enabling more effective implementation of the measure. It is possible to reduce the implementation cost by stopping implementation of a measure that cannot be expected to be effective.

By reflecting the attribute of the respondent in the intention to use, it is possible to further narrow down the target group for implementing the measure. For example, in the measure C: 5-fold point return, the intention of use is high in the Tokyo area and the Kansai area by area, and the intention of use is high in women by gender/age. From this, it is possible to further reduce the implementation cost by limiting the areas and target layers for which the measure is implemented.

The measure selection unit 23 may temporarily store the selected measure in the database 10 or may transmit the measure to the terminal 40. The output destination of the selected measure may be a display device (not illustrated) or a printer (not illustrated).

The measure verification unit 24 verifies the measure based on the change in the customer distribution of the hierarchical segment before and after implementation of the selected measure. Specifically, the measure verification unit 24 acquires the data of the hierarchical segment before and after implementation of the measure selected from the hierarchical segment data 12 of the database 10. The measure verification unit 24 compares the customer distribution of the hierarchical segment before the measure is implemented with the customer distribution of the hierarchical segment after the measure is implemented, and extracts a change in the customer distribution of each segment in the hierarchical segment.

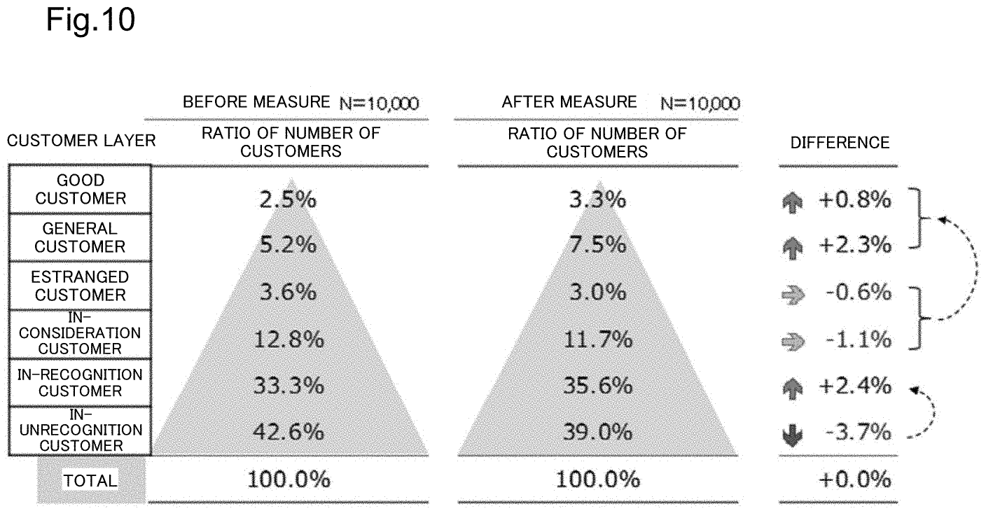

FIG. 10 is a diagram illustrating an example of a change in customer distribution before and after implementation of the measure. In FIG. 10, it can be grasped that the number of good customers, the number of general customers, and the number of in-recognition customers increases, the number of estranged customers and the number of in-consideration customers is unchanged or slightly decreases, and the number of in-unrecognition customers decreases before and after implementation of the measure. It is grasped that, as a result of implementation of the measure, the in-consideration customers can be changed into the purchase customers, and the estranged customers can be changed into the general customers or the good customers. Furthermore, it is understood that there is also an effect on the increase in the degree of recognition from the increase in the number of in-recognition customers and the decrease in the number of in-unrecognition customers.

The measure verification unit 24 can grasp the difference in the customer distribution of each segment before and after implementation of the measure, and can quantitatively evaluate the variation between the segments.

The measure verification unit 24 verifies the influence of the measure on the preference for each segment based on the change in the customer distribution of the hierarchical segment before and after implementation of the measure.

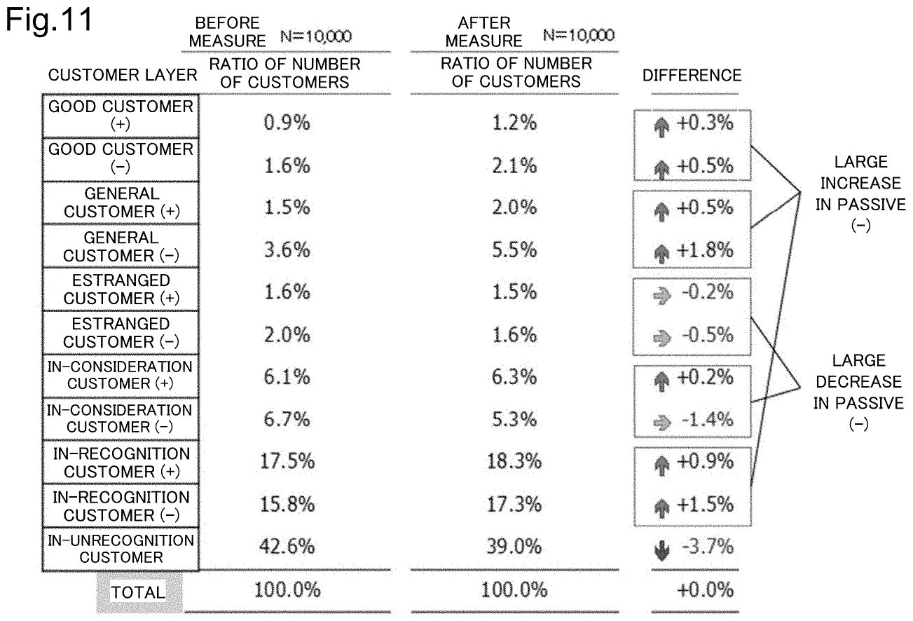

FIG. 11 is a diagram illustrating an example of a change in another customer distribution before and after implementation of the measure. In FIG. 11, the segment increase amount of (−) indicating passive is larger than (+) indicating affirmative in the comparison of the preference between the good customer, the general customer, and the in-recognition customer. The amount of decrease in (−) indicating passive is large in the in-consideration customers. It is understood that the measure has had a certain good effect on the preference of the estranged customers and the in-consideration customers, but may have an adverse effect on the preference of the good customers, the general customers, and the in-recognition customers.

The measure verification unit 24 can grasp the difference before and after implementation of the measure with respect to the distribution of customers with the axis of preference added, and can quantitatively evaluate the influence of implementation of the measure on the preference.

The measure verification unit 24 may temporarily store the verification result in the database 10 or may transmit the verification result to the terminal 40. The output destination of the verified result may be a display device (not illustrated) or a printer (not illustrated).

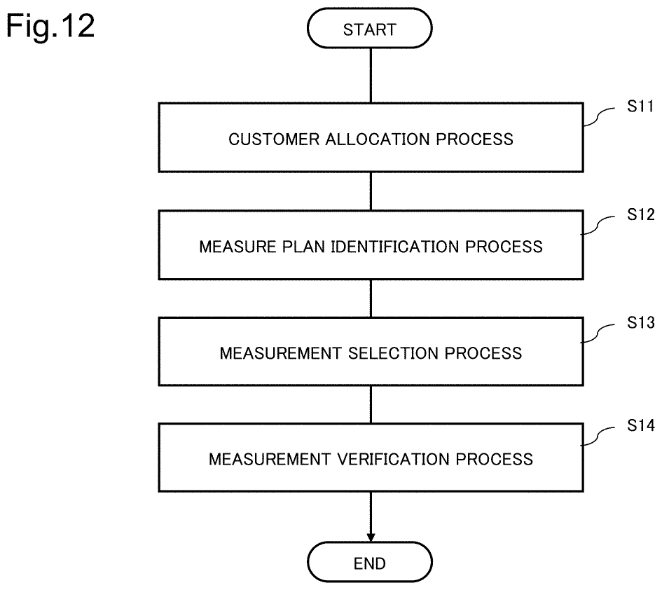

Next, the operation of the measure assistance device 20 of the first example embodiment will be described with reference to the drawings. FIG. 12 is a flowchart illustrating an operation example of the measure assistance device 20.

The customer allocation unit 21 executes the customer allocation process (step S11), and allocates a customer to the hierarchical segment based on the brand recognition, the purchase experience, and the purchase amount or the purchase frequency with respect to the customer. Specifically, the customer allocation unit 21 acquires questionnaire data for the brand included in the market survey data 11 from the database 10. The customer allocation unit 21 allocates a customer to the hierarchical segment based on the brand recognition included in the questionnaire data, the purchase experience, and the purchase amount or the purchase frequency. The hierarchical segment is, for example, a six-segment map.

In a case where the 11 segment map is used as the hierarchical segment, the customer allocation unit 21 allocates a customer to the hierarchical segment based on the brand recognition, the purchase experience, the purchase amount or the purchase frequency, and preference indicating a next purchase intention.

The customer allocation unit 21 generates the number of customers or the ratio of the number of customers of each segment as data of the hierarchical segment.

The measure plan identification unit 22 executes a measure plan identification process (step S12) and identifies a measure plan relevant to a factor by which the customer of the hierarchical segment has moved to the higher-level segment. Specifically, the measure plan identification unit 22 identifies a measure plan based on data of a face-to-face survey on a customer who has moved to the higher-level segment. For example, the measure plan identification unit 22 searches the measure plan data 14 of the database 10 for a measure plan relevant to an answer using a product or a service included in an answer by a customer who has moved to the higher-level segment as a keyword. Based on the search result, the measure plan identification unit 22 identifies a measure plan relevant to a factor by which the customer has moved to the higher-level segment. The measure plan identification unit 22 sends the identified measure plan to the measure selection unit 23. The measure plan identification unit 22 may temporarily store the identified measure plan in the measure plan data 14 of the database 10.

The measure selection unit 23 executes a measure selection process (step S13), and selects, based on the number of use intentions if the identified measure plan were implemented, a measure from the plurality of measure plans. Specifically, the measure selection unit 23 selects a measure from the measure plans based on the market survey data 11 for the measure plans.

The measure selection unit 23 acquires data of the market survey for the measure plan identified from the market survey data 11 of the database 10. The measure selection unit 23 calculates the number of use intentions if the measure plan were implemented based on the acquired data of the market survey. The measure selection unit 23 selects a measure from a plurality of measure plans based on the number of use intentions. The measure selection unit 23 may calculate the number of use intentions for attribute of each respondent who has expressed the use intention.

Regarding the selection of the measure, by reflecting the attribute of the respondent in the intention to use, it is possible to further narrow down the target group to implement the measure.

The measure selection unit 23 may temporarily store the selected measure in the database 10 or may transmit the measure to the terminal 40. The output destination of the selected measure may be a display device (not illustrated) or a printer (not illustrated).

The measure verification unit 24 executes a measure verification process (step S14), and verifies the measure based on the change in the customer distribution of the hierarchical segment before and after implementation of the measure selected by the measure selection unit 23. Specifically, the measure verification unit 24 acquires the data of the hierarchical segment before and after implementation of the measure selected from the hierarchical segment data 12 of the database 10. The measure verification unit 24 compares the customer distribution of the hierarchical segment before implementation of the measure with the customer distribution of the hierarchical segment after implementation of the measure, and extracts a change in the customer distribution of each segment in the hierarchical segment.

The measure verification unit 24 can grasp the difference in the customer distribution of each segment before and after implementation of the measure, and can quantitatively evaluate the variation between the segments.

The measure verification unit 24 verifies the influence of the measure on the preference for each segment based on the change in the customer distribution of the hierarchical segment before and after implementation of the measure.

The measure verification unit 24 can grasp the difference before and after implementation of the measure with respect to the distribution of customers with the axis of preference added, and can quantitatively evaluate the influence of implementation of the measure on the preference.

### Effects of First Example Embodiment

According to the measure assistance device 20 of the first example embodiment, the measure plan identification unit 22 identifies a measure plan relevant to a factor by which the customer of the hierarchical segment has moved to the higher-level segment. The measure selection unit 23 selects a measure from among a plurality of measure plans based on the number of use intentions if the measure plan were implemented. The measure verification unit 24 verifies the measure based on the change in the customer distribution of the hierarchical segment before and after implementation of the measure. With this configuration, the measure assistance device 20 can assist in creating a measure effective for moving the segment of a customer. Specifically, it is possible to select a measure for customers and objectively evaluate the effects of the measure. The effective measure can be grasped in advance, and the cost of the measure can be reduced by avoiding implementation of the wasteful measure.

### Second Example Embodiment

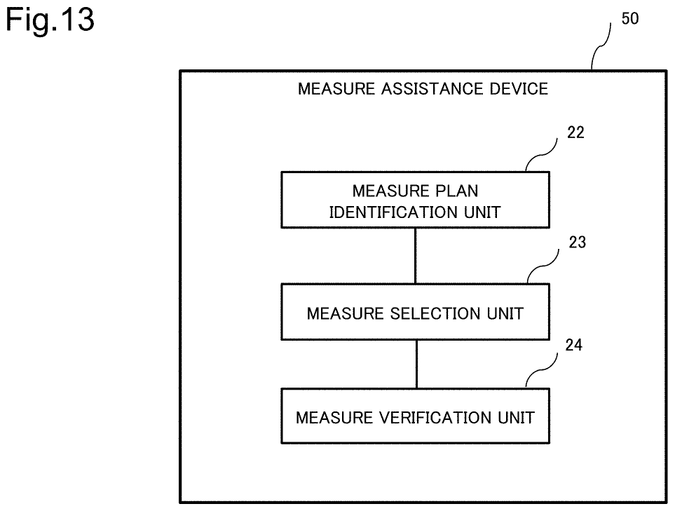

A measure assistance device according to the second example embodiment will be described with reference to the drawings. FIG. 13 is a block diagram illustrating a configuration example of the measure assistance device of the second example embodiment. A measure assistance device 50 illustrated in FIG. 13 includes the measure plan identification unit 22, the measure selection unit 23, and the measure verification unit 24. The measure assistance device 50 of the second example embodiment has a configuration in which the customer allocation unit 21 is removed from the measure assistance device 20 of the first example embodiment.

The measure plan identification unit 22 identifies a measure plan relevant to a factor by which the customer of the hierarchical segment has moved to a higher-level segment. Specifically, the measure plan identification unit 22 identifies a measure plan for sales promotion based on data of a face-to-face survey on a customer who has moved to the higher-level segment.

For example, the measure plan identification unit 22 searches the measure plan data 14 of the database 10 for a measure plan relevant to an answer using a product or a service included in an answer by a customer who has moved to the higher-level segment as a keyword. Based on the search result, the measure plan identification unit 22 identifies a measure plan relevant to a factor by which the customer has moved to the higher-level segment.

The measure selection unit 23 selects a measure from among a plurality of measure plans based on the number of use intentions if the measure plan were implemented. Specifically, the use intention is the intention of the customer to use the measure plan. Specifically, the measure selection unit 23 calculates the number of use intentions based on the market survey data 11 for the measure plans, and selects the measure from the measure plans.

For example, the measure selection unit 23 acquires data of the market survey for the measure plan identified from the market survey data 11 of the database 10. The measure selection unit 23 calculates the number of use intentions if the measure plan were implemented based on the acquired data of the market survey. The measure selection unit 23 selects a measure from a plurality of measure plans based on the number of use intentions. The measure selection unit 23 may calculate the number of use intentions for attribute of each respondent who has expressed the use intention.

The measure selection unit 23 selects a measure from among the plurality of measure plans based on the number of use intentions if the measure plan were implemented. This makes it possible to implement the more effective measure. It is possible to reduce the implementation cost by stopping implementation of a measure that cannot be expected to be effective.

The measure verification unit 24 verifies the measure based on the change in the customer distribution of the hierarchical segment before and after implementation of the selected measure. Specifically, the measure verification unit 24 acquires the data of the hierarchical segment before and after implementation of the measure selected from the hierarchical segment data 12 of the database 10. The measure verification unit 24 compares the customer distribution of the hierarchical segment before the measure is implemented with the customer distribution of the hierarchical segment after the measure is implemented, and extracts a change in the customer distribution of each segment in the hierarchical segment.

The measure verification unit 24 can grasp the difference in the customer distribution of each segment before and after implementation of the measure, and can quantitatively evaluate the variation between the segments.

The measure verification unit 24 verifies the influence of the measure on the preference for each segment based on the change in the customer distribution of the hierarchical segment before and after implementation of the measure.

The measure verification unit 24 can grasp the difference before and after implementation of the measure with respect to the distribution of customers with the axis of preference added, and can quantitatively evaluate the influence of implementation of the measure on the preference.

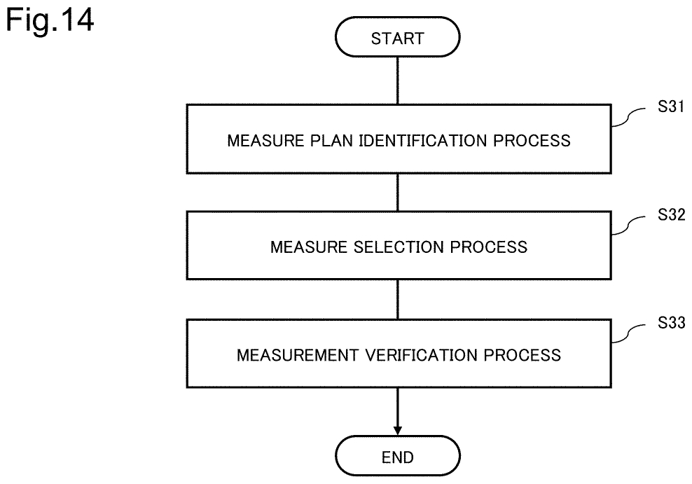

Next, the operation of the measure assistance device 50 of the second example embodiment will be described with reference to the drawings. FIG. 14 is a flowchart illustrating an operation example of the measure assistance device 50.

The measure plan identification unit 22 executes a measure plan identification process (step S31) and identifies a measure plan relevant to a factor by which the customer of the hierarchical segment has moved to the higher-level segment. Specifically, the measure plan identification unit 22 identifies a measure plan based on data of a face-to-face survey on a customer who has moved to the higher-level segment. The measure plan identification unit 22 sends the identified measure plan to the measure selection unit 23. The measure plan identification unit 22 may temporarily store the identified measure plan in the measure plan data 14 of the database 10.

The measure selection unit 23 executes a measure selection process (step S32), and selects, based on the number of use intentions if the identified measure plan were implemented, a measure from a plurality of measure plans. Specifically, the measure selection unit 23 selects a measure from the measure plans based on the market survey data 11 for the measure plans.

The measure selection unit 23 acquires data of the market survey for the measure plan identified from the market survey data 11 of the database 10. The measure selection unit 23 calculates the number of use intentions if the measure plan were implemented based on the acquired data of the market survey. The measure selection unit 23 selects a measure from a plurality of measure plans based on the number of use intentions. The measure selection unit 23 may calculate the number of use intentions for attribute of each respondent who has expressed the use intention. The measure selection unit 23 selects a measure from the measure plans based on the number of use intentions for each measure plan.

The measure verification unit 24 executes a measure verification process (step S33), and verifies the measure based on the change in the customer distribution of the hierarchical segment before and after implementation of the measure selected by the measure selection unit 23. Specifically, the measure verification unit 24 acquires the data of the hierarchical segment before and after implementation of the measure selected from the hierarchical segment data 12 of the database 10. The measure verification unit 24 compares the customer distribution of the hierarchical segment before implementation of the measure with the customer distribution of the hierarchical segment after implementation of the measure, and extracts a change in the customer distribution of each segment in the hierarchical segment.

The measure verification unit 24 can grasp the difference in the customer distribution of each segment before and after implementation of the measure, and can quantitatively evaluate the variation between the segments.

The measure verification unit 24 verifies the influence of the measure on the preference for each segment based on the change in the customer distribution of the hierarchical segment before and after implementation of the measure.

The measure verification unit 24 can grasp the difference before and after implementation of the measure with respect to the distribution of customers with the axis of preference added, and can quantitatively evaluate the influence of implementation of the measure on the preference.

### Effects of Second Example Embodiment

According to the measure assistance device 50 of the second example embodiment, the measure plan identification unit 22 identifies a measure plan relevant to a factor by which the customer of the hierarchical segment has moved to the higher-level segment. The measure selection unit 23 selects a measure from among a plurality of measure plans based on the number of use intentions if the measure plan were implemented. The measure verification unit 24 verifies the measure based on the change in the customer distribution of the hierarchical segment before and after implementation of the measure. With this configuration, the measure assistance device 50 can assist in creating a measure effective for moving the segment of a customer. Specifically, it is possible to select a measure for customers and objectively evaluate the effects of the measure. The effective measure can be grasped in advance, and the cost of the measure can be reduced by avoiding implementation of the wasteful measure.

(Hardware Configuration)

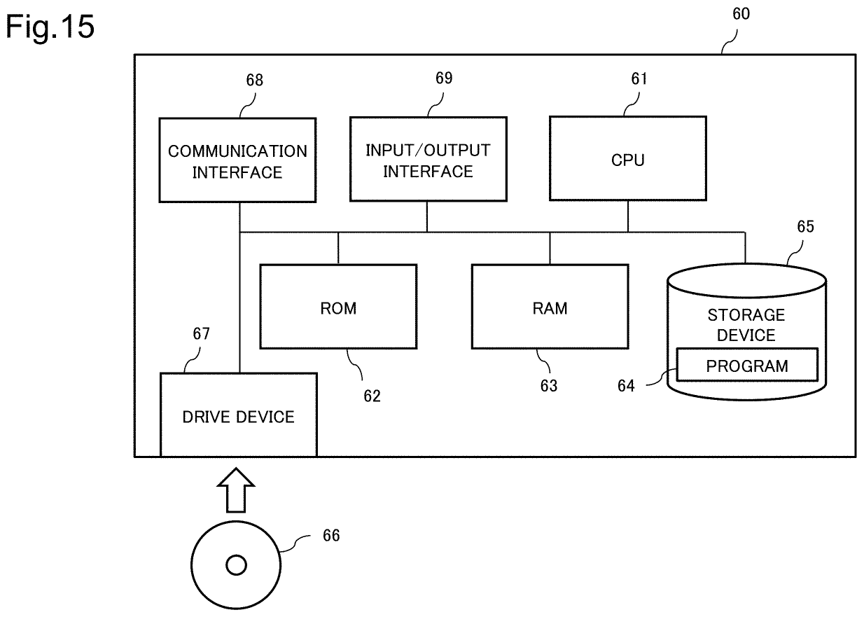

In the example embodiment, some or all of respective components in the measure assistance device 20 illustrated in FIG. 3 or the measure assistance device 50 illustrated in FIG. 13 can also be achieved by using, for example, an any combination of the computer 60 and the program illustrated in FIG. 15. As an example, the computer 60 includes the following configuration.
CPU 61
ROM 62
RAM 63
A storage device 65 storing a program 64 and another data
Drive device 67 that reads and writes recording medium 66
Communication interface 68
Input/output interface 69 for inputting/outputting data

For example, each component of the measure assistance device 20 in the first example embodiment is achieved by the CPU 61 acquiring and executing the program 64 for achieving these functions. The program 64 for achieving the function of each component of the measure assistance device 20 is stored in the storage device 65 or the RAM 63 in advance, for example, and is read by the CPU 61 as necessary. The program 64 may be supplied to the CPU 61 via the communication network, or may be stored in advance in the recording medium 66, and the drive device 67 may read the program and supply the program to the CPU 61.

There are various modifications of the implementation method of each device. For example, the measure assistance device 20 may be achieved by an any combination of separate information processing devices and programs for each component. A plurality of components included in the measure assistance device 20 may be achieved by an any combination of one computer 60 and a program.

Part or all of respective components of the measure assistance device 20 are achieved by another general-purpose or dedicated circuit, processor, or the like, or a combination thereof. These may be configured by a single chip or may be configured by a plurality of chips connected via a bus.

Part or all of respective components of the measure assistance device 20 may be achieved by a combination of the above-described circuit and the like and a program.

In a case where some or all of respective components of the measure assistance device 20 are achieved by a plurality of information processing devices, circuits, and the like, the plurality of information processing devices, circuits, and the like may be disposed in a centralized manner or in a distributed manner. For example, the information processing device, the circuit, and the like may be achieved as a form in which each of the information processing device, the circuit, and the like is connected via a communication network, such as a client and server system, a cloud computing system, and the like.

While the invention has been particularly shown and described with reference to present example embodiments thereof, the invention is not limited to the example embodiments. It will be understood by those of ordinary skill in the art that various changes in form and details may be made therein without departing from the spirit and scope of the present invention as defined by the claims.

### REFERENCE SIGNS LIST

10 database
11 market survey data
12 hierarchical segment data
13 face-to-face survey data
20, 50 measure assistance device
21 customer allocation unit
22 measure plan identification unit
23 measure selection unit
24 measure verification unit

What is claimed is:

1. A measure assistance device comprising:
one or more memories storing instructions; and
one or more processors configured to execute the instructions to:
identify a measure plan relevant to a factor by which a customer in a hierarchical segment has moved to a higher-level segment;
select, based on the number of use intentions if the measure plan were implemented, a measure from a plurality of the measure plans; and
verify the selected measure based on a change in customer distribution of the hierarchical segment before and after implementation of the selected measure.

2. The measure assistance device according to claim 1, wherein the one or more processors configured to execute the instructions to:
allocate the customer to the hierarchical segment based on brand recognition, a purchase experience, and a purchase amount or a purchase frequency with respect to the customer.

3. The measure assistance device according to claim 2, wherein the one or more processors configured to execute the instructions to:
allocate the customer to the hierarchical segment based on the brand recognition, the purchase experience, the purchase amount or the purchase frequency, and a preference indicating a next purchase intention.

4. The measure assistance device according to claim 1, wherein the one or more processors configured to execute the instructions to:
identify the measure plan based on data of a face-to-face survey on the customer allocated to the higher-level segment.

5. The measure assistance device according to claim 1, wherein the one or more processors configured to execute the instructions to:
calculate the number of the use intentions based on market survey data for the measure plan.

6. The measure assistance device according to claim 5, wherein the one or more processors configured to execute the instructions to:
calculate the number of the use intentions for attribute of a respondent who has indicated the use intention in the market survey data for the measure plan.

7. The measure assistance device according to claim 3, wherein the one or more processors configured to execute the instructions to:
verify an influence of the measure on the preference for each of the segment based on the change in customer distribution of the hierarchical segment before and after implementation of the measure.

8. A measure assistance method comprising:
identifying a measure plan relevant to a factor by which a customer in a hierarchical segment has moved to a higher-level segment;
selecting, based on the number of use intentions if the measure plan were implemented, a measure from a plurality of the measure plans; and
verifying the selected measure based on a change in customer distribution of the hierarchical segment before and after implementation of the selected measure.

9. A recording medium storing a program for causing a computer to execute:
identifying a measure plan relevant to a factor by which a customer in a hierarchical segment has moved to a higher-level segment;
selecting, based on the number of use intentions if the measure plan were implemented, a measure from a plurality of the measure plans; and
verifying the selected measure based on a change in customer distribution of the hierarchical segment before and after implementation of the selected measure.
